(19) United States
(12) Patent Application Publication
(10) Pub. No.: US 2009/0239134 A1
(43) Pub. Date: Sep. 24, 2009

(54) Holding device and portable electronic device

(75) Inventor: Tien-Chung Tseng, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/219,477

(22) Filed: Jul. 23, 2008

(30) Foreign Application Priority Data
Mar. 19, 2008 (TW) 097204675

(51) Int. Cl. H01M 2/10

(52) U.S. Cl. 429/100

(57) ABSTRACT

The holding device of the present invention is used for holding at least one battery. The holding device comprises a main body, a positioning unit, and at least one elastic unit wherein the main body has at least one opening and a battery holder, and the battery holder is used for holding at least one battery; the positioning unit has at least one protrusion, and the at least one protrusion can pass through the at least one opening; and the at least one elastic unit is mounted to the main body, wherein each elastic unit has a battery contact part and a protrusion contact part. By means of the above structure, when the battery holder holds the at least one battery, and the at least one protrusion of the positioning unit passes through the at least one opening, the at least one protrusion will exert force on the protrusion contact part, such that the battery contact part will exert force on the at least one battery.

### BACKGROUND OF THE INVENTION

1. Field of the Invention

The present invention relates to a holding device and portable electronic device; more particularly, the present invention discloses a holding device for holding a battery, and a portable electronic device with the holding device.

2. Description of the Related Art

A portable electronic device (such as a mobile phone) is generally arranged with a battery, such that the battery can provide power for operation of the portable electronic device. Conventionally, because a battery holder of the portable electronic device is further required to comprise electrode plates, the battery holder has to arrange a reserved space for the electrode plates. Therefore, the battery holder is slightly longer than the battery such that there is an obvious interval between the battery holder and the battery. When the portable electronic device sustains an impact (for example, when it is dropped), the two ends of the battery may become separated from the electrode plates, thus resulting in power failure. As a result, the portable electronic device cannot operate normally; more seriously, the above situation might also cause loss of important data. Furthermore, when placing the battery into the battery holder, a user has to exert force on the electrode plates, which can be inconvenient because the battery has a relatively small volume.

In order to solve the above power failure problem, in prior arts, some manufacturers adopt a design using electrode plates with a larger modulus of elasticity. Although the above design indeed reduces the likelihood of power failure when the portable electronic device sustains an impact, the user has to exert a stronger force to the electrode plates with the larger modulus of elasticity when installing the battery into the battery holder, and it is also more difficult for the user to remove the battery. There is no such prior art provided with a holding device designed both to solve the power failure problem when the portable electronic device sustains an impact and to provide an energy-saving battery installation/removal mechanism.

Therefore, it is desirable to provide a holding device and portable electronic device to mitigate and/or obviate the aforementioned problems.

### SUMMARY OF THE INVENTION

It is an object of the present invention to provide a holding device used for holding a battery.

It is another object of the present invention to provide a portable electronic device with a holding device.

To achieve the aforementioned objects, the portable electronic device of the present invention comprises a holding device, and the holding device comprises a main body, a positioning unit and at least one elastic unit, wherein the main body has at least one opening and a battery holder, and the battery holder is used for holding the at least one battery; the positioning unit has at least one protrusion, and the at least one protrusion can pass through the at least one opening; and the at least one elastic unit is mounted to the main body, wherein each of the at least one elastic units has a battery contact part and a protrusion contact part. By means of the above structure, when the battery holder holds the at least one battery, and the at least one protrusion of the positioning unit passes through the at least one opening, the at least one protrusion will exert force on the protrusion contact part, such that the battery contact part will exert force on the at least one battery.

According to one of the preferred embodiments of the present invention, the length of the battery holder is substantially equal to the length of the at least one battery, and the battery contact part of the elastic unit further comprises a bending part.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a portable electronic device of the present invention.

FIG. 2 is an exploded view of the portable electronic device of the present invention.

FIG. 3 is a schematic drawing of a positioning unit of a holding device of the present invention.

FIG. 4 is a schematic drawing of an empty battery holder.

FIG. 5 is a schematic drawing of the battery holder holding a battery wherein the positioning unit is not yet disposed to the opening.

FIG. 6 is a schematic drawing of the battery holder holding the battery wherein the positioning unit has been disposed to the opening.

FIG. 7 and FIG. 8 are schematic drawings of a holding device of another embodiment of the present invention.

### DETAILED DESCRIPTION OF THE PREFERRED EMBODIMENT

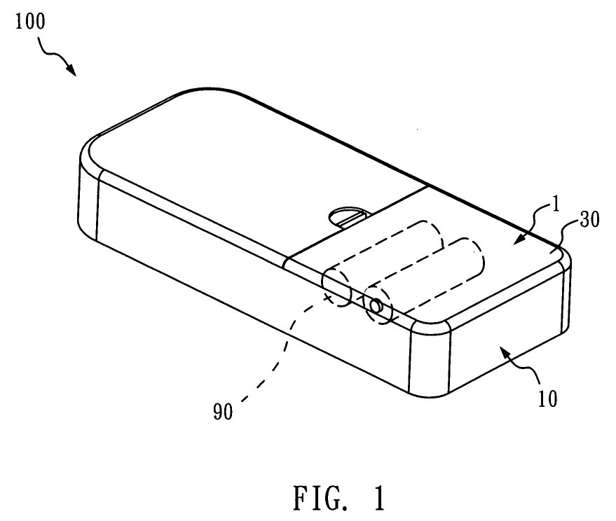

First, please refer to FIG. 1, which is a schematic drawing of a portable electronic device of the present invention. The portable electronic device 100 comprises a holding device 1. Batteries 90 can be mounted by means of the holding device 1. The holding device 1 can be used in all kinds of portable electronic devices using batteries 90; for example, a mobile phone, a camera, a personal digital assistant (PDA), a global positioning system (GPS), a walkman, a remote controller, and so on.

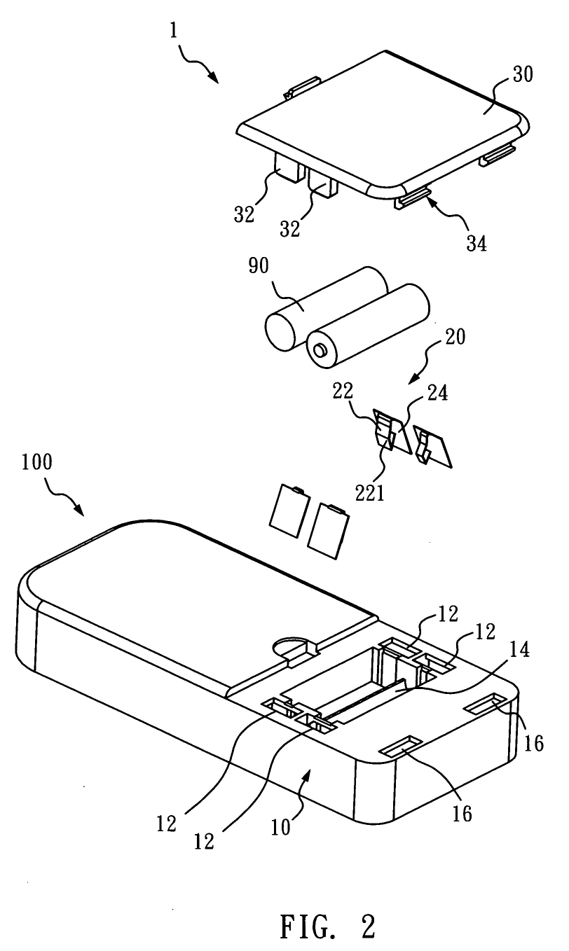

Please refer to FIG. 2, which is an exploded view of the portable electronic device of the present invention. The holding device 1 comprises a main body 10, elastic units 20 and a positioning unit 30. The main body 10 has an opening 12 and a battery holder 14. The battery holder 14 is substantially used for holding the batteries 90; that is, the length of the battery holder 14 is substantially equal to the length of the batteries 90, such that the battery holder 14 can efficiently limit the position of the batteries 90 so as to efficiently reduce the likelihood of a power failure.

In this embodiment, the battery holder 14 is used for holding two AA batteries. Please note that the size and number of the batteries to be placed into the battery holder 14 are not limited to the above description. Because the shape of the battery holder 14 is associated with the batteries 90, in one embodiment of the present invention, the battery holder 14 can be applicable to either AAA batteries or lithium-ion batteries by simply remodeling the shape of the battery holder 14.

The opening 12 is close to the electrodes of the batteries 90. In this embodiment, because the battery holder 14 can hold two batteries 90, there are four openings 12. Please note that the number of the openings 12 is not limited to the above description. For example, two adjacent openings 12 can be combined into one.

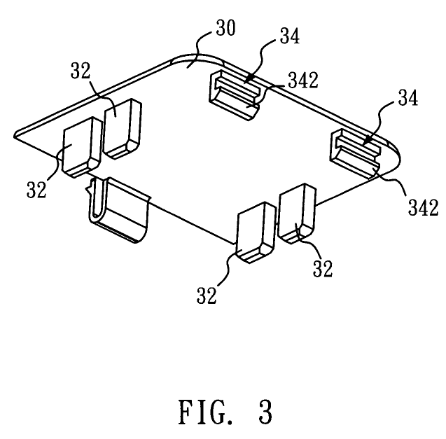

Please refer to both FIG. 2 and FIG. 3. FIG. 3 is a schematic drawing of a positioning unit of the holding device of the present invention. The positioning unit 30 has protrusions 32, wherein the number of the protrusions 32 is associated with the number of the openings 12 of the main body 10, such that the protrusions 32 can pass through the openings 12. In this embodiment, there are four protrusions 32. Please note that the number of the protrusions 32 is not limited to the above description.

In this embodiment, the positioning unit 30 is in the form of a battery cover, which can be separately mounted to the main body 10. The positioning unit 30 comprises hook-shaped mounting units 34. The main body 10 comprises fastening holes 16. By mounting the mounting units 34 to the fastening holes 16, the positioning unit 30 can be mounted to the main body 10. In this embodiment, each of the mounting units 34 has an oblique part 342. The oblique parts 342 can contact edges of the fastening holes 16 so as to guide the positioning unit 30 to be mounted to the main body 10. Please note that the structure of the positioning unit 30 is not limited to the above description.

The elastic units 20 are mounted to the main body 10. Each of the elastic units 20 has a battery contact part 22 and a protrusion contact part 24. When the battery holder 14 holds batteries 90, and the protrusions 32 of the positioning unit 30 pass through the openings 12, the protrusions 32 will exert force on the protrusion contact parts 24, and the force will be directly transmitted to the battery contact parts 22, such that the battery contact parts 22 will exert force on the electrodes of the batteries 90, thus generating an electronic connection. In this embodiment, there are four elastic units 20, but please note that the number of the elastic units 20 is not limited to the above description. Further, the elastic units 20 can also be other units capable of pushing against the batteries 90.

In this embodiment, the elastic units 20 are leaf springs. The battery contact part 22 of the elastic unit 20 comprises a bending part 221. The object of the bending part 221 is to increase its modulus of elasticity so as to increase the force against the batteries 90. Further, if the protrusion contact part 24 of the elastic unit 20 directly contacts the battery contact part 20 after being forced, the modulus of elasticity of the elastic unit 20 can be increased so as to increase the force against the batteries 90.

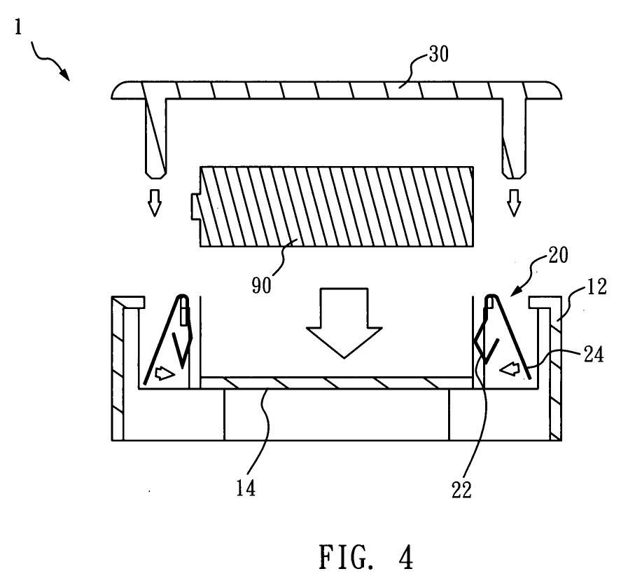

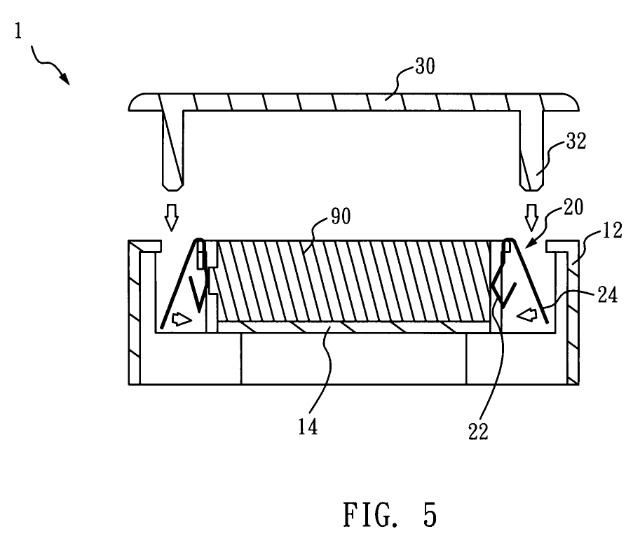

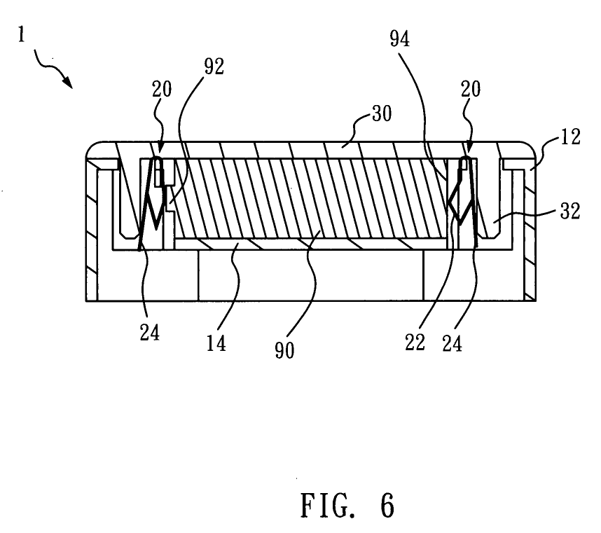

Please refer to FIGS. 4 to 6 for the explanation, stage by stage, of the usage of the holding device 1 of the present invention. FIG. 4 is a schematic drawing of an empty battery holder. FIG. 5 is a schematic drawing of the battery holder holding a battery wherein the positioning unit is not yet disposed to the opening. FIG. 6 is a schematic drawing of the battery holder holding the battery wherein the positioning unit has been disposed to the opening.

Please refer to FIG. 4 first. At this time, a user can easily put the battery 90 into the matching battery holder 14 without being obstructed by the elastic units 20. FIG. 5 illustrates the stage after the battery 90 has been put into the battery holder 14, and, at this time, the battery contact parts 22 of the elastic units 20 do not yet fix the position of the battery 90.

Then the user places the positioning unit 30 into the openings 12 to reach the stage shown in FIG. 6. From the stage shown in FIG. 5 to the stage shown in FIG. 6, the user has to exert force on the positioning unit 30 such that the protrusions 32 can act against the elasticity of the protrusion contact parts 24 of the elastic units 20; as a result, the protrusions 32 can be completely placed into the protrusions 32. When placing the positioning unit 30 into the openings 12, the user can use the fastening holes 16 as a pivot so as to place the positioning unit 30 into the openings 12 by means of rotation, thus saving energy.

The shapes of the protrusion contact parts 24 will be changed due to the force; as a result, the protrusion contact parts 24 will transmit the elasticity to the battery contact parts 22 such that the battery contact parts 22 will exert force on the electrodes of the battery. In this embodiment, the elastic units 20 (as shown in FIG. 6) are respectively disposed next to a positive electrode 92 and a negative electrode 94 of the battery 90. Therefore, battery contact parts 22 of these two elastic units 20 will respectively exert force on the positive electrode 92 and the negative electrode 94 of the battery 90, such that the battery 90 can be completely positioned in the battery holder 14. Consequently, when the portable electronic device 100 sustains an impact (as when dropped), the battery contact parts 22 will not easily be separated from the electrodes of the battery 90; therefore, the likelihood of power failure is reduced.

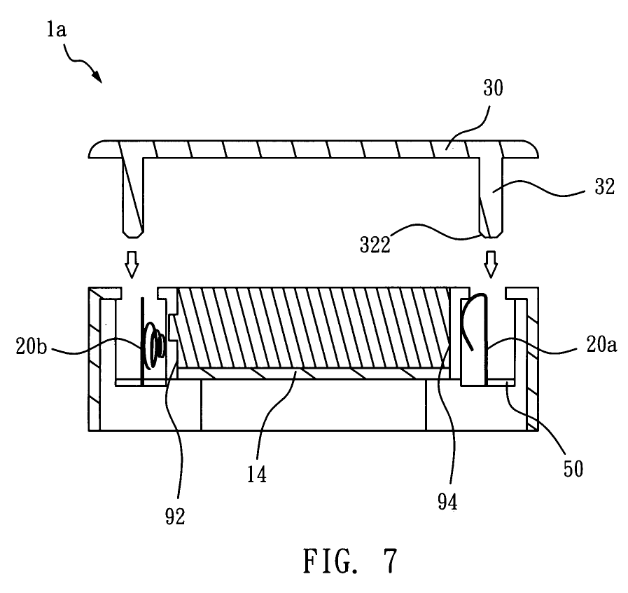

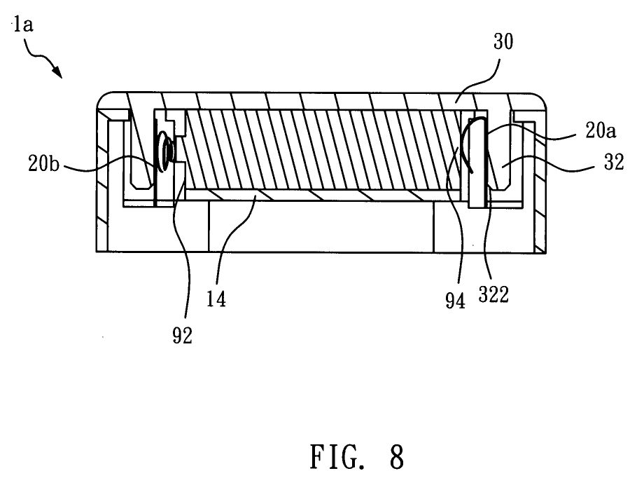

Please refer to both FIG. 7 and FIG. 8, which are schematic drawings of a holding device of another embodiment of the present invention. The difference between this and the above embodiments is the structure of the elastic units. In this embodiment, an elastic unit 20b pushing against the positive electrode 92 of the battery 90 is a helical spring, and an elastic unit 20a pushing against the negative electrode 94 of the battery 90 is a leaf spring, wherein the leaf spring is mounted to the main body 10 by means of a slide 50. When the user places the protrusions 32 of the positioning unit 30 into the openings 12, the elastic unit 20a will move towards the negative electrode 94 of the battery 90 along the slide 50 so as to push against the battery 90.

Please refer again to FIG. 7 and FIG. 8. In this embodiment, each of the protrusions 32 comprises an oblique side 322. The oblique sides 322 can contact the protrusion contact parts 24, such that the protrusions 32 can be placed into the openings 12 more easily.

Although the present invention has been explained in relation to its preferred embodiments, it is to be understood that many other possible modifications and variations can be made without departing from the spirit and scope of the invention as hereinafter claimed.

What is claimed is:

1. A holding device, used for holding at least one battery, the holding device comprising:
a main body comprising at least one opening and a battery holder, wherein the battery holder is substantially used for holding the at least one battery;
a positioning unit comprising at least one protrusion, wherein the at least one protrusion can pass through the at least one opening; and
at least one elastic unit connected to the main body, wherein each of the at least one elastic units comprises a battery contact part and a protrusion contact part;
wherein by means of the above structure, when the battery holder holds the at least one battery, and the at least one protrusion of the positioning unit passes through the at least one opening, the at least one protrusion will exert force on the protrusion contact part, such that the battery contact part will exert force on the at least one battery.

2. The holding device as claimed in claim 1, wherein the length of the battery holder is substantially equal to the length of the at least one battery.

3. The holding device as claimed in claim 1, wherein the battery contact part further comprises a bending part.

4. The holding device as claimed in claim 1, wherein each of the at least one elastic units is a leaf spring or a spring.

5. The holding device as claimed in claim 1, wherein each of the at least one elastic units is mounted to the main body by means of a slide.

6. The holding device as claimed in claim 1, wherein each of the at least one protrusions further comprises an oblique side, wherein the oblique side can contact the protrusion contact part.

7. The holding device as claimed in claim 1, wherein the positioning unit further comprises at least one mounting unit, the main body further comprises at least one fastening hole, and the positioning unit is mounted to the main body by mounting the at least one mounting unit to the at least one fastening hole.

8. The holding device as claimed in claim 7, wherein each of the at least one mounting units further comprises an oblique part.

9. The holding device as claimed in claim 1, wherein there are four protrusions, four elastic units, and four openings.

10. The holding device as claimed in claim 1, wherein each of the at least one batteries is a AA battery, a AAA battery, or a lithium-ion battery.

11. A portable electronic device, used for holding at least one battery, the portable electronic device comprising:
a main body comprising at least one opening and a battery holder, wherein the battery holder is substantially used for holding the at least one battery;
a positioning unit comprising at least one protrusion, wherein the at least one protrusion can pass through the at least one opening; and
at least one elastic unit connected to the main body, wherein each of the at least one elastic units comprises a battery contact part and a protrusion contact part;
wherein by means of the above structure, when the battery holder holds the at least one battery, and the at least one protrusion of the positioning unit passes through the at least one opening, the at least one protrusion will exert force on the protrusion contact part, such that the battery contact part will exert force on the at least one battery.

12. The portable electronic device as claimed in claim 11, wherein the length of the battery holder is substantially equal to the length of the at least one battery.

13. The portable electronic device as claimed in claim 11, wherein the battery contact part further comprises a bending part.

14. The portable electronic device as claimed in claim 11, wherein each of the at least one elastic units is a leaf spring or a spring.

15. The portable electronic device as claimed in claim 11, wherein each of the at least one elastic units is mounted to the main body by means of a slide.

16. The portable electronic device as claimed in claim 11, wherein each of the at least one protrusions further comprises an oblique side, wherein the oblique side can contact the protrusion contact part.

17. The portable electronic device as claimed in claim 11, wherein the positioning unit further comprises at least one mounting unit, the main body further comprises at least one fastening hole, and the positioning unit is mounted to the main body by mounting the at least one mounting unit to the at least one fastening hole.

18. The portable electronic device as claimed in claim 17, wherein each of the at least one mounting units further comprises an oblique part.

19. The portable electronic device as claimed in claim 11, wherein there are four protrusions, four elastic units, and four openings.

20. The portable electronic device as claimed in claim 11, wherein each of the at least one batteries is a AA battery, a AAA battery, or a lithium-ion battery.
